(19) United States
(12) Patent Application Publication
(10) Pub. No.: US 2004/0033083 A1
(43) Pub. Date: Feb. 19, 2004

(54) Electrophotographic image forming device with mixer for mixing developer and method thereof

(75) Inventors: Hirotaka Fukuyama, Mishima-shi (JP); Koichiro Sato, Mishima-shi (JP)

Correspondence Address: FOLEY AND LARDNER, SUITE 500, 3000 K STREET NW, WASHINGTON, DC, 20007, US

(73) Assignee: Toshiba Tec Kabushiki Kaisha

(21) Appl. No.: 10/218,092

(22) Filed: Aug. 14, 2002

(51) Int. Cl. G03G 15/08

(52) U.S. Cl. 399/53; 399/254

(57) ABSTRACT

An electrophotographic image forming apparatus is provided which is reduced in size and weight, provides a good printed image, and causes no troubles during developer exchange. The electrophotographic image forming apparatus stirs a developer while performing a printing operation. The apparatus comprises a developer case for containing the developer, a developer stirring mixer provided within the developer case opposite the inner surface of the developer case for stirring the developer by rotation, and a driver for rotating the mixer at a selected one of a plurality of rotational speeds that the driver has, wherein when a quantity of the developer within the developer case is below a predetermined quantity, the driver rotates the mixer at a lower speed than when the quantity of the developer is above the predetermined quantity.

### BACKGROUND OF THE INVENTION

1. Field of the Invention

The present invention relates to electrophotographic image forming apparatus.

2. Related Background Art

Electrophotographic image forming apparatus such as copy machines comprise a photosensitive drum that prints on a sheet a visible image formed thereon with toner and a developing device that feeds the photosensitive drum with the toner. One type of the developing device includes a two-component developing device that uses a mixture of non-magnetic toners and magnetic carriers as a developer. The developing device comprises a mixer and a development roller housed within the developer case. The mixer is rotated by a driver to thereby stir the non-magnetic toners and magnetic carriers while feeding the mixture to the development roller. The development roller then leads the developer to the photosensitive drum that then transfers the non-magnetic toners to a sheet for printing purposes. The developer is exchanged periodically; for example, each time 30,000 pages are printed.

In the printing operation, rapid rotation of the mixer is tried in order to stir the developer rapidly and to feed the developer more rapidly to the development roller. The rotational speed of the mixer is determined in consideration of the image quality alone, and not in consideration of a quantity of the developer present around the mixer.

### SUMMERY OF THE INVENTION

The inventor used to employ a mixer that comprises a SUS (metal) shaft 115A with a stirring ABS-resin vane of FIG. 4. In order to reduce the weight of the electrophotographic image forming apparatus, the inventor made the whole mixer with resin to thereby reduce the size of the whole apparatus, which led necessarily to a reduction in the gap between the elements of the apparatus. The inventor also found that troubles occurred in the mixer made of resin in its entirety when the developer was to be replaced with another.

More specifically, the inventor noticed that when a mixer having a resin shaft was rotated, a shake of the shaft was prone to occur compared to the mixer having a metal shaft 115A of FIG. 4, and hence use of the mixer having a resin shaft produced a strange noise during the developer exchanging time. The inventor suspected that this was because during the developer exchanging time, the developer quantity was excessively reduced and could not function as a sufficient cushion, and the edge of the stirring vane 115B of the mixer struck the inner surface of the developer case due to the shake of the shaft 115A. The inventor also noticed that the stirring vane 115B were therefore broken or damaged. In order to avoid production of such strange noise, damage, etc., the gap between the outer edge of the vane 115B and the inner surface of the developer case could be increased, which, however, is not expedient. This is because an increase in the gap would not only defeat miniaturization of the apparatus, but also achieve no satisfactory mixing of the toners and carriers to thereby fail to print a good image during a printing time.

The inventor also found experimentally that even a mixer 115 using a metal shaft 115A such as was shown in FIG. 4 produced noise due to the mixer 115 rubbing against the inner surface of the developer case because the mixer 115 was shaken greatly when the quantity of the developer present around the mixer 115 was reduced excessively.

The present invention has been made in view of the above problems. It is an object of the present invention to provide an electrophotographic image forming apparatus reduced in size and weight, free from troubles during developer exchanging time, and providing a good printed image during printing time.

According to embodiments of the present invention, there is provided an electrophotographic image forming apparatus that stirs a developer while performing a printing operation, said apparatus comprising:

a developer case for containing the developer;

a developer stirring mixer provided within said developer case opposite the inner surface of said developer case for stirring the developer by rotation; and

a driver for rotating said mixer at a selected one of a plurality of rotational speeds that said driver has, wherein when a quantity of the developer within said developer case is below a predetermined quantity, said driver rotates said mixer at a lower speed than when the quantity of the developer is above the predetermined quantity.

According to embodiments of the present invention, there is provided an electrophotographic image forming apparatus comprising:

a photosensitive drum having a photosensitive layer formed on its outer surface on which a latent image is formed in printing;

a mixer having a rotational shaft and a stirring vane formed helically around said rotational shaft, said rotational shaft and said stirring vane being integrally made of resin, said mixer being rotated around its shaft during printing time, new developer feeding time and developer exchanging time, the developer comprising magnetic carriers and non-magnetic toners, said mixer stirring and carrying the developer during printing time;

a magnet roller to which said mixer carries the developer during the printing time, said magnet roller having a magnet housed therein, said magnet roller attracting the magnetic carriers thereto by its magnetic force and carrying the magnetic carriers and the non-magnetic toners attracted to the magnetic carriers to a developing section where the non-magnetic toners adhere to the latent image formed on said photosensitive drum; and

a driver for driving said mixer at a selected one of a plurality of rotational speeds, wherein during a new developer feeding time or developer exchanging time, said driver drives said mixer at a lower speed than during printing time.

According to embodiments of the present invention, there is provided a method for driving a mixer of electrophotographic image forming apparatus, said mixer provided within a developer case and stirring a developer present within said developer case while performing a printing operation,

wherein the rotational speed of the mixer during a new developer feeding time or a developer exchanging time is low compared to that of the mixer during printing time.

### BRIEF DESCRIPTION OF THE DRAWINGS

FIG. 1 is a plan view of a part of an electrophotographic image forming apparatus as an embodiment of the present invention.

FIG. 2(a) is a cross-sectional view of the apparatus of FIG. 1 taken along a line C-C of FIG. 1, and FIG. 2(b) is an enlarged illustration of a part of the developer.

FIG. 3 is a graph of the rotational speed of the mixer during the developer exchanging operation, wherein FIG. 3(a) is a timing chart of developer discharging time, and FIG. 3(b) is a timing chart of developer feeding time.

FIG. 4 illustrates a part of a mixer of an electrophotographic image forming apparatus preceding the present invention.

### DESCRIPTION OF THE PREFERRED EMBODIMENT

Referring to Figures, the electrophotographic image forming apparatus as an embodiment of the present invention will be described next.

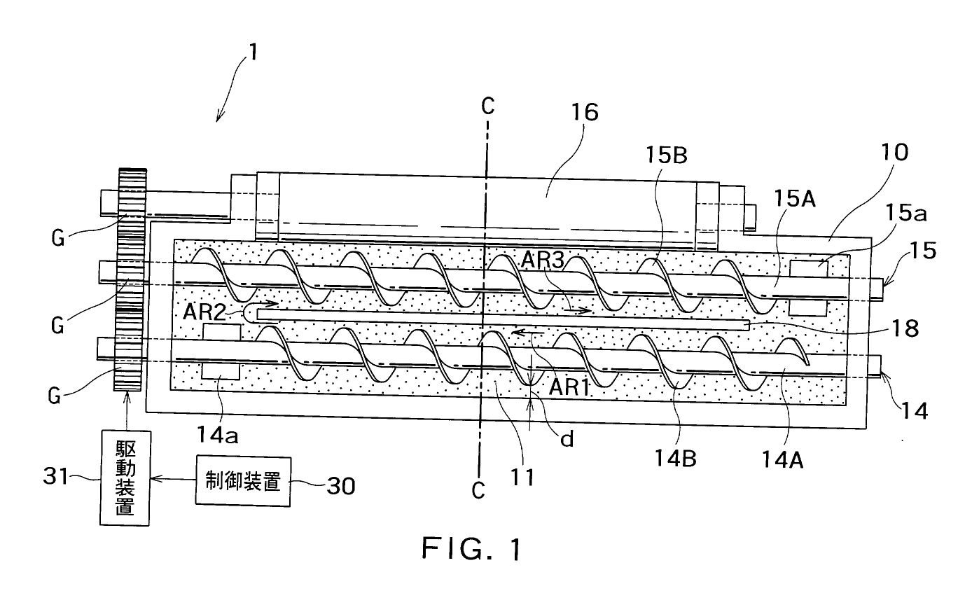

As will be seen in FIGS. 1-3, one of the features of the electrophotographic image forming apparatus of this embodiment is that the rotational speed V2 of first and second mixers 14 and 15 during developer exchanging time T2 and T3 is low compared to the rotational speed V1 of the mixers 14 and 15 during the normal printing operation time. This prevents occurrence of a strange noise during developer exchanging operation.

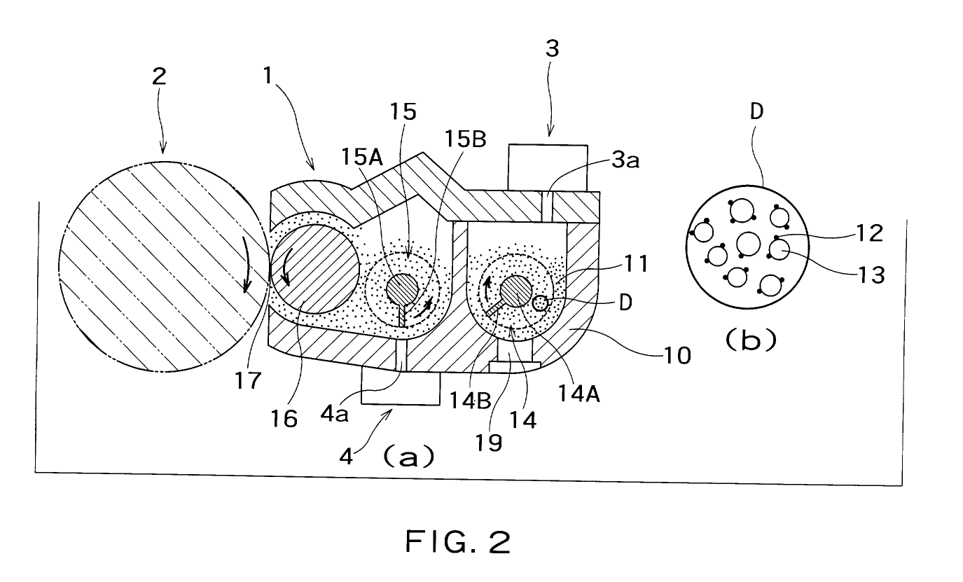

FIG. 1 is a plan view of a part of the electrophotographic image forming apparatus of the embodiment. FIG. 2(a) is a cross-sectional view taken along a line C-C in FIG. 1. FIG. 2(b) is an enlarged illustration of a part D of a developer 11. As will be seen in FIG. 2, the apparatus comprises a developing device 1, a photosensitive drum 2, a developer feed device 3, and a developer discharge device 4, which will be described sequentially in this order.

First, the developing device 1 comprises within a developer case 10 the first and second mixers 14 and 15 and a magnet roller (development roller) 16. The developer case 10 contains the developer 11 that, as shown in FIG. 2(b), is composed of two components; i.e. non-magnetic toners 12 and magnetic carriers 13 that attract the toners 12 thereto. The developer 11 is exchanged with another each time a predetermined number of pages are printed. The non-magnetic toners 12 are composed of colored chargeable fine powder of resin. The magnetic carrier 13 has an average grain size larger than the non-magnetic toner 12 and attracts the non-magnetic toners 12 thereto, using its electrostatic force produced due to charging. In more detail, the magnetic carrier 13 has an average grain size of 30-100 μm and is made of an iron, ferrite or magnetite ferromagnetic material.

The first and second mixers 14 and 15 are provided within the development case 10 in which developer 11 is contained. As shown in FIG. 1, the first and second mixers 14 and 15 are provided within the developer case 10 opposite its inner surface. A partition 18, open at least one end, is provided between the two mixers 14 and 15. The mixers 14 and 15 are rotated to stir the developer 11 and to feed the developer 11 in opposite axial directions AR1 and AR3. In printing time, the developer 11 is carried from the magnet roller 16 to the photosensitive drum 2. In developer exchanging time, the remaining old developer 11 is carried from a developer discharge outlet 4a into the developer discharge device 4 while a new developer 11 fed from the developer feed device 3 through a feed inlet 3a into the developer case 10 is carried. The rotation of the mixers 14 and 15 is performed by gears G that are rotated by a driver 31 based on a signal from a controller 30. One of the features of the present embodiment is that the driver has a plurality of rotational speeds and the rotational speed of the mixers 14 and 15 is changed depending upon a quantity of the developer 11 present within the developer case 10. More specifically, in the present embodiment the driver is set at a rotational speed V1 (600 rpm) during printing time and at V2 (500 rpm) during developer exchanging time.

The structure of the mixers 14 and 15 will be next described more specifically. The mixers 14 and 15 have rotational shafts 14A and 15A and stirring vanes 14B and 15B provided around the shafts 14A and 15A, respectively, to stir the developer 11 while feeding the developer in axial directions AR1 and AR3. The stirring vanes 14B and 15B are helical ones formed around the shafts 14A and 15A, respectively. The outer edges of the vanes 14B and 15B are opposite the inner surface of the developer case 10. The shafts 14A and 15A and vanes 14B and 15B of the mixers 14 and 15 are integrally made of FRP (Fiberglass Reinforced Plastics), which includes a complex synthetic plastic material containing glass and carbon fibers embedded as reinforcing materials and is lightweight and high in mechanical strength, corrosion resistance and moldability. Thus, in the apparatus of this embodiment the mixers 14 and 15 and the whole apparatus are reduced in weight. More specifically, the characteristics of the FRP used in this embodiment are as follows: the specific weight is 1.3-1.4; the tensile strength is 800-1300 kgf/cm²; the tensile extension is 2-3%; the bend strength is 1,300-1,600 kgf/cm²; the bend elastic modulus is 75,000-85,000 kgf/cm²; and the thermal deformation temperature (18.6 kgf/cm²) is 120-140° C. The mixer shafts 14A and 15A have a diameter, for example, of 5-10 mm and the helical stirring vanes 14B and 15B have a diameter, for example, of 15-20 mm. The mixers 14 and 15 have a length, for example, of 30-50 cm. The gap d between the developer case 10 and the outer edge of each of the stirring vanes 14B and 15B is narrow, or not more than 1.5 mm. This leads to a reduction in the apparatus size and provides improved stirring of the developer 11 and a higher quality image. Reference symbols 14a and 15a denote a bearing.

The magnet roller 16 to which the mixer 15 carries the developer 11 has a magnet therein. The magnet roller 16 attracts magnetic carriers 13 thereto, using its magnetic force. The magnet roller 16 is rotated by the gears G to thereby carry the magnetic carriers 13 and non-magnetic toners 12 attracted beforehand to the magnetic carriers 13 to the developing section 17 (FIG. 2).

At the developing section 17, the photosensitive drum 2 is provided opposite the magnet roller 16. A latent image is preformed by laser on an outer surface of the photosensitive drum 2. By applying a development bias between the photosensitive drum 2 and the magnet roller 16, non-magnetic toners 12 are attracted electrically to the latent image on the photosensitive drum 2 to thereby achieve a developing operation.

Of course, a developer feeding mechanism composed of the developer feed device 3 and the developer feed inlet 3a, and a developer discharge mechanism composed of the developer discharge device 4 and the developer discharge outlet 4a are not directly related to the printing operation during the printing time. The developer feed mechanism 3, 3a and the developer discharge mechanism 4, 4a discharge the old developer out of the developer case 10 and feed a new developer into the developer case during the developer exchanging time. A developer sensor 19 senses a quantity of the developer 11 present within the developer house 10 during the developer exchanging time. The sensor 19 may be a piezoelectric sensor, a photosensor, a magnetic sensor or the like.

The printing operation and the developer exchanging operation to be performed in the electrophotographic image forming apparatus of this embodiment will be described next.

The printing operation is similar to that performed in the conventional apparatus and will not be explained in detail. Briefly, in the printing operation a printing mode is selected in which the non-magnetic toners 12 and the magnetic carriers 13 are stirred by the mixer 14 disposed on this side while being carried leftwards (AR1) in FIG. 1. Then, a flow of the developer is reversed (AR2) and then carried rightwards (AR3) in FIG. 1 while being stirred by the mixer 15. During stirring, the non-magnetic toners 12 and the magnetic carriers 13 are charged electrically due to friction. As will be seen in FIG. 2, the non-magnetic toners 12 are attracted to the magnetic carriers 13 by an electrostatic force due to the charging. The rotational speed of the mixers 14 and 15 is set at V1 (600 rpm) suitable for stirring. The magnetic carriers 13 and the non-magnetic toners 12 are carried to the magnetic roller 16 while being stirred so. The magnetic roller 16 then attracts the magnetic carriers 13 by its magnetic force and then carries the magnetic carriers 13 and the non-magnetic toners 12 attracted to the magnetic carrier 13 to the developing section 17. At this developing section 17, the non-magnetic toners 12 move from the magnetic carriers 13 to the latent image formed on the photosensitive drum 2 to thereby form a visible image. The latent image on the photosensitive drum 2 has a larger attracting force on the non-magnetic toners 12 than on the magnetic carriers 13, so that the latent image attracts the non-magnetic toners 12 at the developing section 17. The photosensitive drum 2 then transfers to a predetermined sheet the visible image formed with the non-magnetic toners 12 for printing purposes. The above summarizes the printing operation.

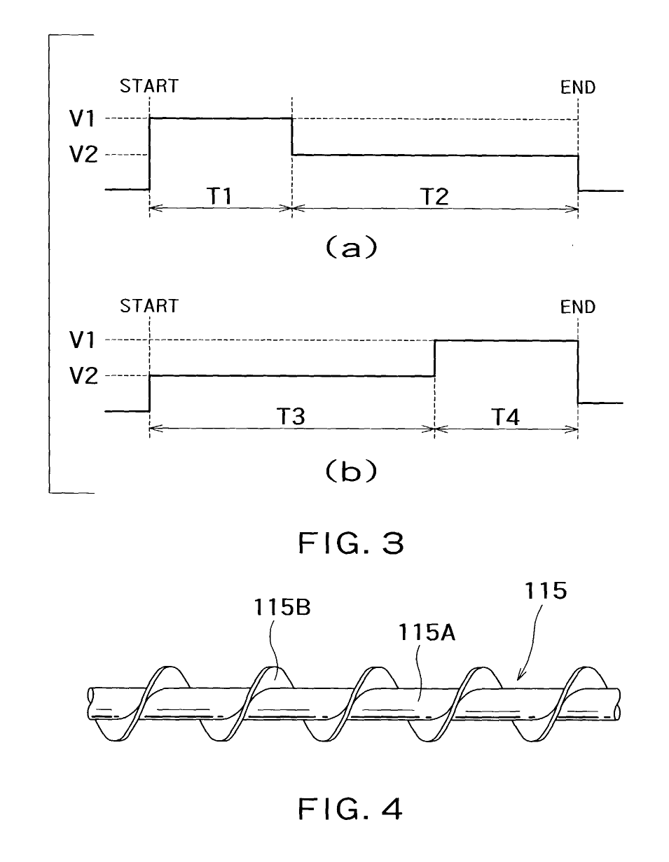

Referring to FIG. 3, developer exchanging operation will be next described in more detail. FIG. 3 illustrates the rotational speeds of the mixers 14 and 15 during the developer exchanging time in the electrophotographic image forming apparatus of FIGS. 1 and 2. FIG. 3(a) is a timing chart of developer discharging time. FIG. 3(b) is a timing chart of developer feeding time. Reference symbols V1 and V2 denote the rotational speeds of the mixer 15 in the printing and developer exchanging time, respectively.

First, a developer exchanging mode is selected and then the developer sensor 19 provided below the mixer 14 is turned on. As will be seen in FIG. 3(a), the mixers 14 and 15 are then rotated at V1 to start to discharge the old developer 11from the developer discharge device 4 through the developer discharge outlet 4a.

When a time T1 has elapsed since the start of the developer discharging operation and the developer sensor 19 senses that a quantity of the developer 11 has decreased below a predetermined quantity, the rotational speed of the mixer 14 and 15 decrease to V2 (500 rpm), lower than the rotational speed V1 (600 rpm) of the printing time. During the time T2, the mixer 14 and 15 are rotated at the speed V2 to thereby discharge the developer 11. During the time T2, the developer 11 does not sufficiently function as a cushion, but the mixer shafts 14a and 15b are prevented from shaking by reducing the rotational speed of the mixers 14 and 15 to V2.

In more detail, in the present embodiment the mixer shafts 14A and 15A are made of FRP, as mentioned above, in order to reduce the apparatus weight. The FRP is easily bent compared to the metal member 115A of FIG. 4. In addition, as described above, in the present embodiment the gap d between each of the stirring vanes 14B and 15B and the developer case 10 is reduced in order to reduce the size of the apparatus. Therefore, in the present embodiment if the mixers 14 and 15 are rotated at about 600 rpm, which is similar to that employed in printing time, when the developer is discharged, the shafts 14A and 15A may shake greatly to thereby cause the stirring vanes 14B and 15B to contact with the inner surface of the developer case 10. In order to reduce the shakes of the shafts 14A and 15A, the rotational speed of the shafts 14A and 15A is reduced during the developer discharging time T2. Thus, the developer 11 present within the developer case 10 is discharged from the developer discharge mechanism 4, 4a.

After the developer discharging has ended, a new developer 11 starts to be feed through the developer feed inlet 3a from the developer feed device 3 into the developer case 10. In this case, the mixers 14 and 15 are rotated at V2, as shown in FIG. 3(b). In the developer feeding time T3, a quantity of the developer 11 within the developer case 10 is not sufficient until a predetermined quantity of the developer is fed. Therefore, in order to reduce the shakes of the shafts 14A and 15A, the shafts 14A and 15A are rotated at the low speed V2 (500 rpm).

When a time T3 has elapsed since the feed of the developer started and the developer sensor 19 senses that the quantity of the developer 11 in the developer case 10 has exceeded the predetermined one, the rotational speed of the mixer 14 and 15 increases to V1 (600 rpm). In the present embodiment, T2 and T3 are together referred to as a developer exchanging time. Then, only for a time T4 after the rotational speed of the mixers 14 and 15 has reached V1, the mixers 14 and 15 are rotated to sufficiently stir the non-magnetic toners 12 and the magnetic carriers 13 fed through the developer feed mechanism 3, 3a into the developer case 10. The developer exchanging mode is then changed to the print mode to thereby terminate the developer exchange.

The feeding operation of the developer 11 from the developer feed mechanism 3, 3a is similar to a manner in which a new developer 11 is fed when a new electrophotographic image forming apparatus of this embodiment is used. In this case, a new developer feeding mode is selected, the developer sensor 19 is turned on, and the developer 11 is then fed into the developer case 10. During the new developer feeding time T3 in the new developer feeding operation, the rotational speed of the mixers 14 and 15 is set at V2.

While in the exchanging or new feeding operation of the developer 11 the developer sensor 19 is illustrated as turned on only when either the developer exchange mode or the new developer feed mode is selected, the developer sensor 19 can be turned on even when the printing mode is selected.

While in the developer exchange the rotational speed of the mixers 14 and 15 is illustrated as automatically changed with the aid of the developer sensor 19, the rotational speed of the mixer 14 and 15 may be fixed to V2 during the times T1 and T4 where the developer exchanging mode has been selected. That is, the rotational speed of the mixers 14 and 15 can be changed to V2 by selecting the developer exchanging mode. This applies likewise to the feeding operation of the new developer 11.

Since the electrophotographic image forming apparatus, as described above, comprises the mixer 15 made of FRP in its entirety, it is reduced in weight compared to a similar apparatus that comprises a mixer having a metal shaft. In addition, in order to reduce the size of the apparatus the gap between each component is reduced.

One method of reducing the size of the apparatus is to reduce the gap d between the developer case 10 and each of the mixer stirring vanes 14B and 15B, which leads to improved stirring of the developer and providing a high-quality image.

As described above, the electrophotographic image forming apparatus of this embodiment has reduced its size and weight and provides an improved printed image.

In addition, the electrophotographic image forming apparatus of this embodiment eliminates troubles that might occur in the developer exchanging time. More specifically, in the present embodiment the rotational speed of the mixer 15 is set at V1 (600 rpm) suitable for the regular printing operation to be performed when the required quantity of the developer 11 is present in the developer case whereas the rotational speed of the mixer 15 is set at the reduced speed V2 (500 rpm) during the developer discharging time T2 or developer feeding time T3 when the quantity of the developer 11 is reduced. Therefore, even when the developer is reduced in quantity to thereby provide a reduced cushion effect during the developer exchanging times T2 and T3, the shaking magnitudes of the mixer shafts 14A and 15A are reduced to thereby avoid striking of the outer edges of the stirring mixer vanes 14B and 15B against the inner surface of the developer case 10. This prevents production of a strange noise during the developer exchanging times T2 and T3 as well as breakage or damage to the outer peripheries of the vanes 14B and 15B.

According to the inventor's experiments, it is confirmed that when the rotational speed of the mixer 15 in the developer exchanging time T2 and T3 is set at 600 rpm, which equal that of the mixer 15 during printing, a strange noise is produced due to a shake of the mixer 15.

In the electrophotographic image forming apparatus of the embodiment mentioned above, the characteristics of the FRP used in this embodiment are as follows: the specific weight is 1.3-1.4; the tensile strength is 800-1,300 kgf/cm²; the tensile extension was 2-3%; the bend strength is 1,300-1,600 kgf/cm²; the bend elastic modulus is 75,000-85,000 kgf/cm²; and the thermal deformation temperature (18.6 kgf/cm²) is 120-140° C. The rotational speed V1 of the mixers 14 and 15 is set at 600 rpm during printing and at V2 (500 rpm) during the developer exchanging time T2 and T3. These specified values may be replaced with others on demand. According to the inventor's experiments, when the mixers 14 and 15 made of FRP are rotated at V1 in a range of 400-700 rpm and the difference between the rotational speeds V1 and V2 is set at 50-150 rpm, satisfactory results are obtained.

While in the embodiment the rotational speed of the mixers 14 and 15 is illustrated as changed in two steps, it may be changed in three or more steps if the rotational speed of the mixers during the developer exchanging time is low compared to that of the mixers during printing time.

While the embodiment is illustrated where the mixers 14 and 15 are made of FRP, production of a strange noise are prevented even when the mixer 115 having a metal shaft 115 A is used, as shown in FIG. 4.

What is claimed is:

1. An electrophotographic image forming apparatus that stirs a developer while performing a printing operation, said apparatus comprising:
a developer case for containing the developer;
a developer stirring mixer provided within said developer case opposite the inner surface of said developer case for stirring the developer by rotation; and
a driver for rotating said mixer at a selected one of a plurality of rotational speeds that said driver has, wherein when a quantity of the developer within said developer case is below a predetermined quantity, said driver rotates said mixer at a lower speed than when the quantity of the developer is above the predetermined quantity.

2. The electrophotographic image forming apparatus according to claim 1, wherein said driver has at least two rotational speeds for rotating said mixer, that is, a first speed to be employed during printing time, and a second speed lower than said first speed.

3. The electrophotographic image forming apparatus according to claim 2, wherein said driver rotates said mixer at the second speed during a new developer feeding time or a developer exchanging time.

4. The electrophotographic image forming apparatus according to claim 1, wherein said mixer is made of a material containing resin and is formed integrally by the material.

5. The electrophotographic image forming apparatus according to claim 4, wherein the material containing resin comprises fiberglass reinforced plastics.

6. The electrophotographic image forming apparatus according to claim 3, wherein said apparatus has either a developer exchanging mode or a new developer feeding mode in which said driver rotates said mixer at the second rotational speed.

7. The electrophotographic image forming apparatus according to claim 3, further comprising a developer sensor for sensing a quantity of the developer present within said developer case and wherein the rotational speed of said mixer to be driven by said driver is determined depending upon a signal indicative of the sensed quantity of the developer from said developer sensor.

8. The electrophotographic image forming apparatus according to claim 1, wherein said developer case contains at least one of a developer feed mechanism and a developer discharge mechanism, said developer feed mechanism for allowing the developer to be fed into said developer case when the apparatus is newly used or the developer is exchanged, said developer discharge mechanism for allowing the developer to be discharged out of said developer case.

9. An electrophotographic image forming apparatus comprising:
a photosensitive drum having a photosensitive layer formed on its outer surface on which a latent image is formed in printing;
a mixer having a rotational shaft and a stirring vane formed helically around said rotational shaft said rotational shaft and said stirring vane being integrally made of resin, said mixer being rotated around its shaft during printing time, new developer feeding time and developer exchanging time, the developer comprising magnetic carriers and non-magnetic toners, said mixer stirring and carrying the developer during printing time;
a magnet roller to which said mixer carries the developer during the printing time, said magnet roller having a magnet housed therein, said magnet roller attracting the magnetic carriers thereto by its magnetic force and carrying the magnetic carriers and the non-magnetic toners attracted to the magnetic carriers to a developing section where the non-magnetic toners adhere to the latent image formed on said photosensitive drum; and
a driver for driving said mixer at a selected one of a plurality of rotational speeds, wherein during a new developer feeding time or developer exchanging time, said driver drives said mixer at a lower speed than during printing time.

10. A method for driving a mixer of electrophotographic image forming apparatus, said mixer provided within a developer case and stirring a developer present within said developer case while performing a printing operation,
wherein the rotational speed of the mixer during a new developer feeding time or a developer exchanging time is low compared to that of the mixer during printing time.
